(19) United States
(12) Patent Application Publication
(10) Pub. No.: US 2014/0044254 A1
(43) Pub. Date: Feb. 13, 2014

(54) METHODS AND SYSTEMS FOR DISTINGUISHING CALLERS AND INITIATING OR SCHEDULING CALLS

(71) Applicant: Shanmugam Chinnappa, Sterling, VA (US)

(72) Inventor: Shanmugam Chinnappa, Sterling, VA (US)

(73) Assignee: Amdocs Software Systems Limited

(21) Appl. No.: 13/572,734

(22) Filed: Aug. 13, 2012

(51) Int. Cl. H04M 3/00

(52) U.S. Cl. 379/265.12

(57) ABSTRACT

Methods and systems for distinguishing callers and initiating or scheduling a call based, for example, on the reason for their calls are disclosed. The methods and systems receive one or more input selections from an input apparatus. In addition, the methods and systems determine a set of characteristics representative of one or more customer service representative skills. The methods and systems output the set of characteristics to a server. In addition, the methods and systems receive data regarding a target customer service representative associated with the set of characteristics. In addition, communication with the target customer service representative is enabled by the methods and systems using the received data.

### TECHNICAL FIELD

The present disclosure relates to the field of distinguishing callers and initiating or scheduling calls and, more particularly, methods and systems for distinguishing callers and initiating or scheduling calls based, for example, on the reason for their calls.

### BACKGROUND

Companies commonly employ customer service representatives (CSRs) to, for example, interact with company customers. Generally speaking, customers call designated telephone numbers (or utilize some other mechanism) to speak with CSRs. In some instances CSRs answer questions on behalf of a company or companies. In other instances CSRs are trained to field specific technical questions (e.g., trouble shooting) on behalf of a company or companies. In yet other instances, a customer may communicate with a CSR to dispute part of a bill, open a new account, or ask for help regarding a technical problem.

A variety of methodologies exist for managing customer calls to CSRs. For example, a call from a customer may be assigned to a first available CSR, regardless of the reason the customer made the call. However, by assigning a customer call to a CSR without regard to the reason the customer made the call, a CSR would potentially be required to handle any customer call. Training CSRs to potentially handle any customer call can be costly, and can result in CSRs that are less capable of handling given customer communications than specialized CSRs.

To improve training efficiency and CSR performance, some companies may train specialized target CSRs to deal with specific customer issues, such that a plurality of groups of CSRs exist based on their training. In order to connect a customer to a given target CSR among a plurality of types of CSRs, the customer may be required to select a particular option, either digitally or through a verbal command, while communicating with an interactive voice response (IVR) system. For example, a customer may call a designated telephone number, connect to an IVR system, and receive a prompt to enter a series of numbers or other input that provide an indication of the customer's reason for the call. However, such an IVR system can frustrate a customer since a customer is required to spend time specifying his or her reason and then wait, often while connected to the IVR system, until a target CSR becomes available.

Rather than using an IVR system, some companies may route customer communication to a target CSR after an initial CSR determines the reason for the customer's call. For example, an initial human CSR may ask a customer a set of questions to determine the customer's reason for the call and then route the customer's call to a target CSR. However, utilizing multiple layers of CSRs often results in multiple hold times that can also be frustrating to a customer.

Improvements in distinguishing callers, including methods and systems for distinguishing callers based, for example, on the reason for their calls, are desirable.

### SUMMARY

In one disclosed embodiment, a method for a device having a processor, a display, and an input apparatus is disclosed. The method comprises receiving one or more input selections from the input apparatus. In addition, the method comprises determining a set of characteristics representative of one or more customer service representative skills. The method also comprises outputting the set of characteristics to a server. In addition, the method comprises receiving data regarding a target customer service representative associated with the set of characteristics. In addition, the method also comprises enabling the device to communicate with the target customer service representative using the received data.

In another disclosed embodiment, a system is disclosed. The system comprises one or more processors, one or more memories, one or more displays, and program stored in the one or more memories. The program code, when executed by the one or more processors, causes the system to perform the steps of: receiving one or more input selections from the input apparatus, determining a set of characteristics representative of one or more customer service representative skills, outputting the set of characteristics to a server, receiving data regarding a target customer service representative associated with the set of characteristics, and enabling the device to communicate with the target customer service representative using the received data.

In another disclosed embodiment, a method for a server is disclosed. The method comprises receiving a set of characteristics representative of one or more customer service representative skills from a device. In addition, the method comprises determining a target customer service representative associated with the received set of characteristics. The method also comprises determining contact data and time data regarding the target customer service representative. In addition, the method also comprises outputting the contact data and the time data to the device.

In another disclosed embodiment, a server is disclosed. The server comprises one or more processors, one or more memories, and program code stored in the one or more memories. The program code, when executed by the one or more processors, causes the server to perform the steps of: receiving a set of characteristics representative of one or more customer service representative skills from a device, determining a target customer service representative associated with the received set of characteristics, determining contact data and time data regarding the target customer service representative, and outputting the contact data and the time data to the device.

Additional aspects related to the embodiments will be set forth in part in the description which follows, and in part will be obvious from the description, or may be learned by practice of the invention.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates an example system that may be used for implementing the disclosed embodiments.

FIG. 2 illustrates an example system that may be used for implementing the disclosed embodiments.

FIG. 3 illustrates an example method for calling a CSR based on a determined user reason for a call.

FIG. 4 illustrates an example method for calling a CSR based on a determined user reason for a call.

FIG. 5 illustrates an example method for setting a call-back time.

FIG. 6 illustrates an example user device executing an application enabled to determine a user reason for a call and call a CSR based on the determined user reason.

FIG. 7 illustrates an example user device executing an application enabled to determine a user reason for a call and call a CSR based on the determined user reason.

FIG. 8 illustrates an example user device executing an application enabled to determine a user reason for a call and call a CSR based on the determined user reason.

FIG. 9 illustrates an example user device executing an application enabled to determine a user reason for a call and call a CSR based on the determined user reason.

FIG. 10 illustrates an example user device executing an application enabled to set a call-back time.

### DETAILED DESCRIPTION

Reference will now be made in detail to the example embodiments, examples of which are illustrated in the accompanying drawings. Wherever possible, the same reference numbers will be used throughout the drawings to refer to the same or like parts.

Various embodiments for distinguishing callers based, for example, on the reason for their calls are disclosed. A user, and services associated with the user, may first be identified. A reason for a call may be determined by input received by the user device. The determined user reason may be used to determine a target CSR skill set. A plurality of different wait times may be associated with a plurality of different CSRs. By determining a target CSR having the skill set, a wait time associated with the target CSR can be determined along with contact information for the target CSR. The wait time associated with the target CSR may be displayed on the user device, and the user device may be enabled to connect to the target CSR.

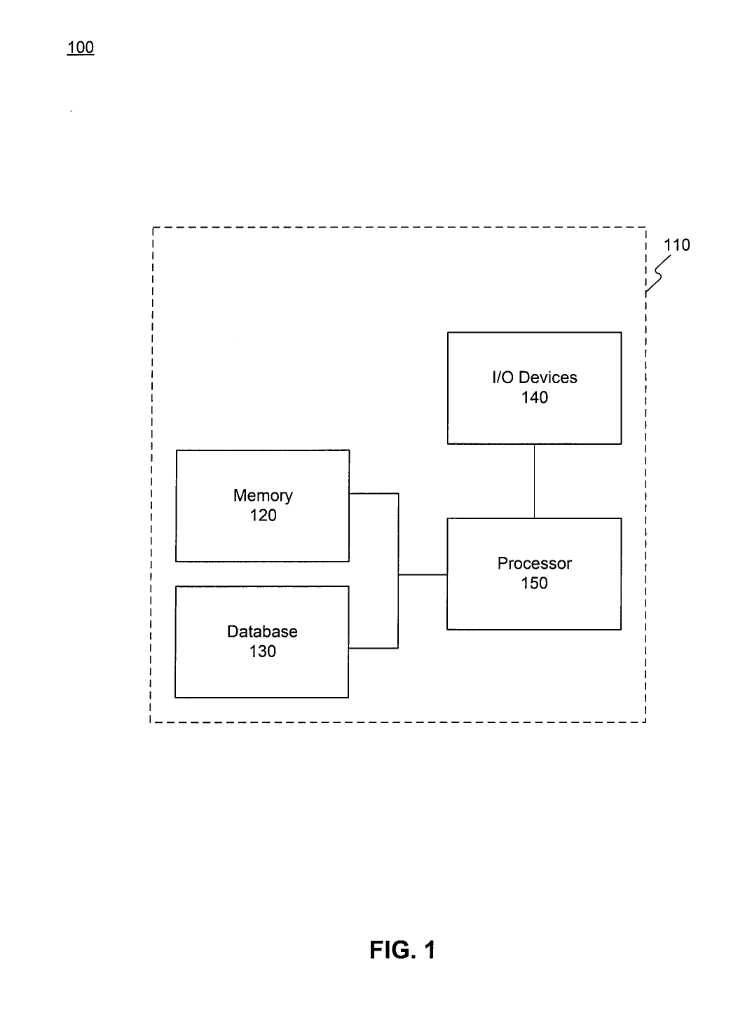

FIG. 1 is a diagram illustrating an example computer system 100 that may be used for implementing the disclosed embodiments. Computer system 100 may include one or more computers 110, which may be servers, personal computers, mobile phones, and/or other types of computing devices. Computer 110 may include, among other things, one or more of the following components: a processor 150, such as a central processing unit (CPU), configured to execute computer program code to perform various processes and methods, including the embodiments herein described; memory 120, such as RAM, EEPROM, and flash memory, to store data and computer program code; database 130 to store tables, lists, or other data structures; and I/O devices 140 such as a keyboard, mouse, and monitor. Each of these components is well-known in the art and will not be discussed further.

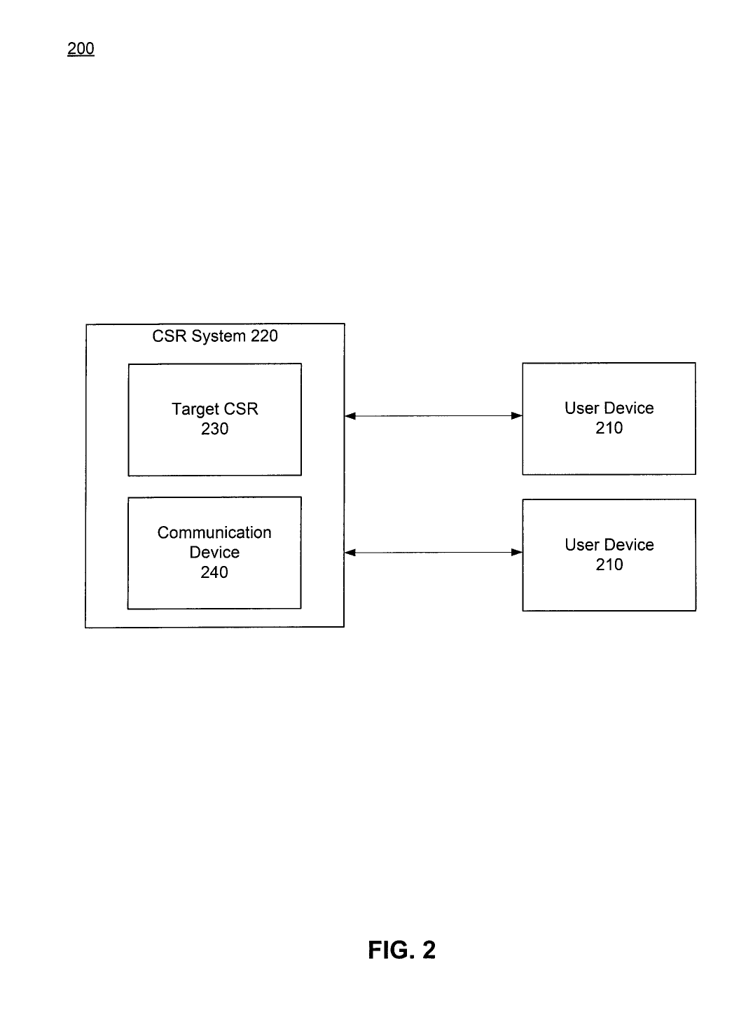

FIG. 2 illustrates an example system 200 that may be used for implementing the disclosed embodiments. System 200 includes one or more user devices 210. A user device 210 may be an electronic device, such as, for example, computer 110, and may enable a user to communicate with a CSR by, for example, voice, video, or text.

System 200 also includes a CSR system 220. CSR system 220 may include a communication device 240 to communicate with a user device 210. In some embodiments, communication device 240 is a server that is enabled to send data to and receive data from a user device 210. In addition, CSR system 220 may include one or more target CSRs 230. A target CSR 230 may refer to any entity, including an individual, organization, or machine, such as computer 110, or a set of individuals, organizations, or machines. A target CSR 230 may be enabled to communicate with a user device 210 by, for example, voice, video, or text. In addition, in some embodiments, communication device 240 is enabled to route a communication, such as a phone call, from a user device 210 to a target CSR 230, and vice versa. While FIG. 2 depicts two user devices 210 and one target CSR 230, the depiction in FIG. 2 is an example, and other systems used to implement the disclosed embodiments may have any number of user devices 210 and target CSRs 230, including a greater number of user devices 210 than target CSRs 230, a greater number of target CSRs 230 than user devices 210, or an equal number of user devices 210 and target CSRs 230.

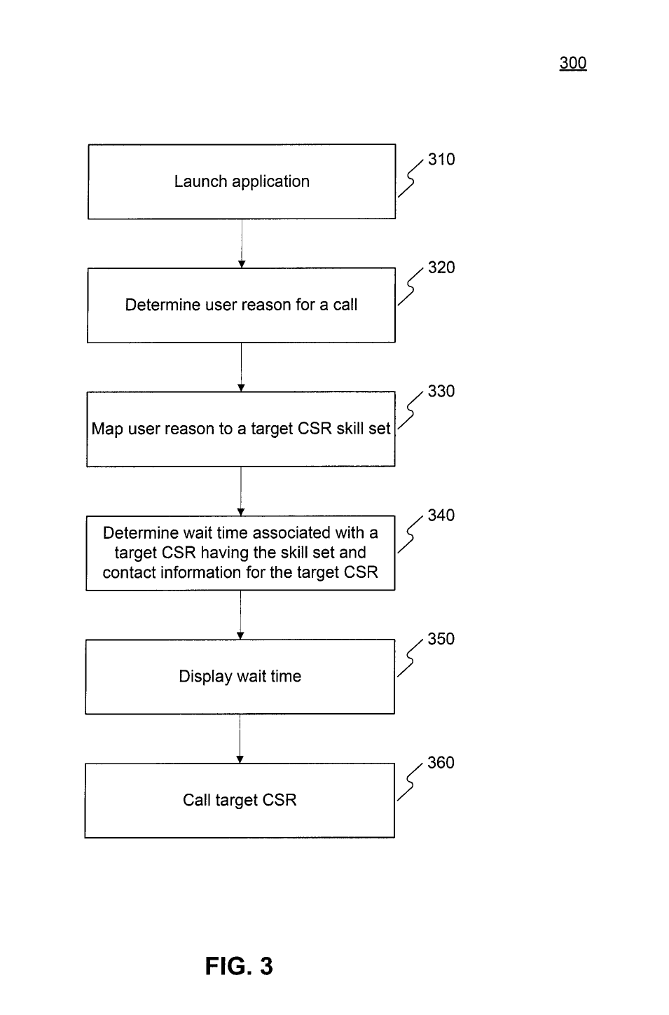

FIG. 3 illustrates an example method 300 for calling a CSR based on a determined user reason for a call. Method 300 begins when a processor launches an application on a user device, such as, for example, user device 210 (step 310). In some embodiments, the application will reside in memory of the user device as computer code. However, the application may also reside in a remote server, accessed, for example, via the Internet using an Internet browser.

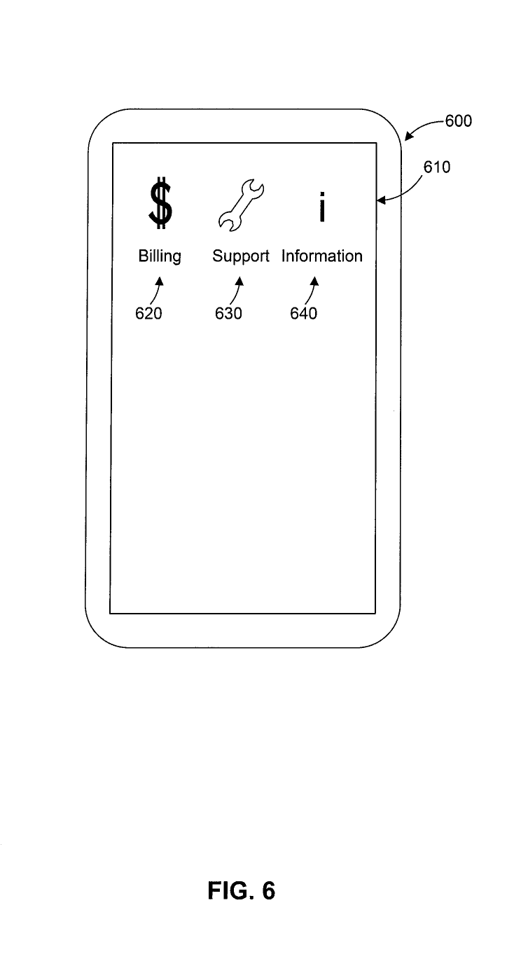

As depicted in FIG. 6, for example, a user device 600 may launch an application and display icons 620, 630, and 640 on a display 610. In some embodiments, the user device 600 may determine the user, and services associated with the user, in order to determine which icons to display. Icons 620, 630, and 640, representative of billing, support, and additional information, respectively, are selectable, and, upon being selected, may each cause one or more actions to occur. In some embodiments, display 610 is a touch-sensitive display. Icons 620, 630, and 640 may comprise visual and/or textual components providing an indication of a given icon's purpose. For example, the icon 620 contains a dollar symbol and the text “billing” to indicate that the processor, upon detecting selection of icon 620, causes device 600 to perform actions related to billing. Similarly, for example, the icon 630 contains a tool symbol and the text “support” to indicate the processor, upon detecting selection of icon 630, causes device 600 to perform actions related to technical support, and icon 640 contains an “i” symbol and the text “information” to indicate that the processor, upon detecting selection of icon 640, causes the device 600 to perform actions related to providing information.

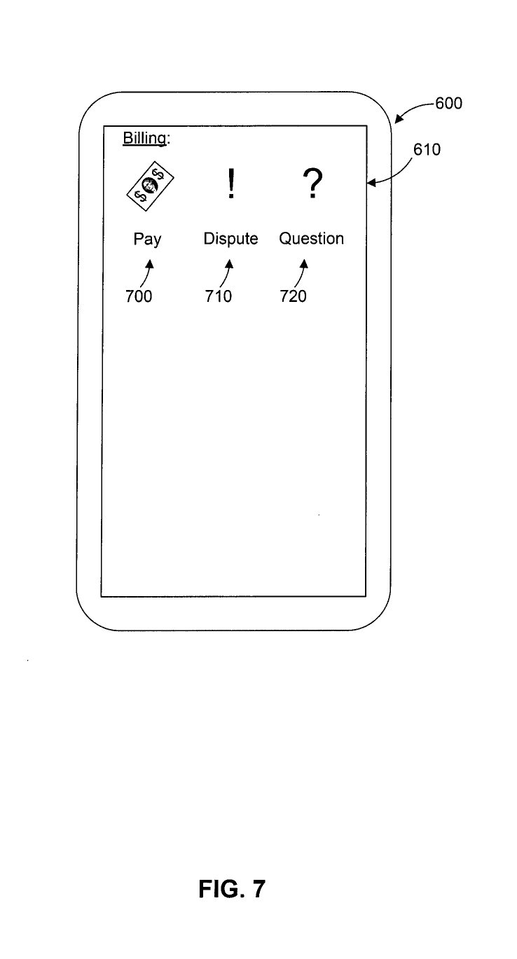

After the application is launched, the processor may determine a user reason for a call (step 320). The user reason may be determined based on input received in the user device, such as, for example, icon selections. For example, a selection of icon 620, depicted in FIG. 6, may be detected by the processor. In response to detecting selection of icon 620, the processor may, for example, cause icons 700, 710, and 720, representative of bill payments, bill disputes, and bill questions, respectively, to be displayed, as depicted in FIG. 7. A selection of, for example, bill payment icon 700 may then be detected by the processor, and, in response to detecting selection of bill payment icon 700, the processor may determine that the user reason for a call is to speak with a CSR regarding a bill payment. In some embodiments, the user reason is determined based on a last selected icon. However, a user reason may be determined in a number of other ways, such as, for example, based on a combination of several icon selections or based on input text from a keyboard.

After the user reason has been determined, the processor may map the user reason to a target CSR skill set (step 330). A target CSR skill set is a set of characteristics that indicate one or more capabilities of a CSR. For example, if the user reason for the call is to speak with a CSR regarding a bill payment, the target CSR skill set may be determined to include an ability to process payments. In some embodiments, the application running on the user device is company specific, using stored relationships between possible user reasons and target CSR skill sets. In addition, in some embodiments, the user device is capable of receiving relationships between possible user reasons and target CSR skill sets from the CSR system. In some embodiments, the target CSR skill set is sent to the CSR system. In addition, while the user reason and target CSR skill set are described in the example above as being determined in the user device, in some embodiments the user device transmits the input received on the user device to the CSR system to determine the user reason and target CSR skill set, and in some other embodiments the user device transmits the determined user reason to the CSR system to determine the target CSR skill set. Thus, in some embodiments, the CSR system stores one or more of: user inputs, user reasons, data regarding relationships between user inputs and user reasons, target CSR skill sets, and/or data regarding relationships between user reasons and target CSR skill sets.

The target CSR skill set may be sent to the CSR system to calculate a wait time for a target CSR associated with the target CSR skill set (step 340). For example, the CSR system may store a database that lists skill sets for CSRs in the CSR system. Using the received target CSR skill set, the example CSR system may select a target CSR whose skill set includes the target CSR skill set. If a plurality of possible target CSRs have a skill set that includes the target CSR skill set, the target CSR may be selected from the set of possible target CSRs based on, for example, CSR availability or experience. For example, a given possible target CSR may be better trained to handle a communication dealing with the target CSR skill set and/or may have a shorter wait time than other possible target CSRs.

In some embodiments, the CSR system periodically calculates wait times associated with CSRs included within the CSR system. For example, wait times associated with CSRs included within the CSR system may be calculated every 10 minutes. In such embodiments, the CSR system determines the wait time associated with the target CSR by finding the most recently calculated wait time associated with the target CSR. In other embodiments, the CSR system calculates a wait time associated with the target CSR on an as-needed basis, such that the wait time is calculated in response to a request to determine the wait time associated with the target CSR.

In some embodiments, the CSR system places the user device on a waiting list associated with the target CSR. If there is no wait time associated with the target CSR, the CSR system may place the user device at a first position on the waiting list or, alternatively, not place the user device on a waiting list. In some embodiments, the CSR system transmits the wait time associated with the target CSR to the user device. In addition, in some embodiments, the CSR system transmits contact information for the target CSR, such as, for example, the target CSR's phone number, IP address, or other identifier, to the user device.

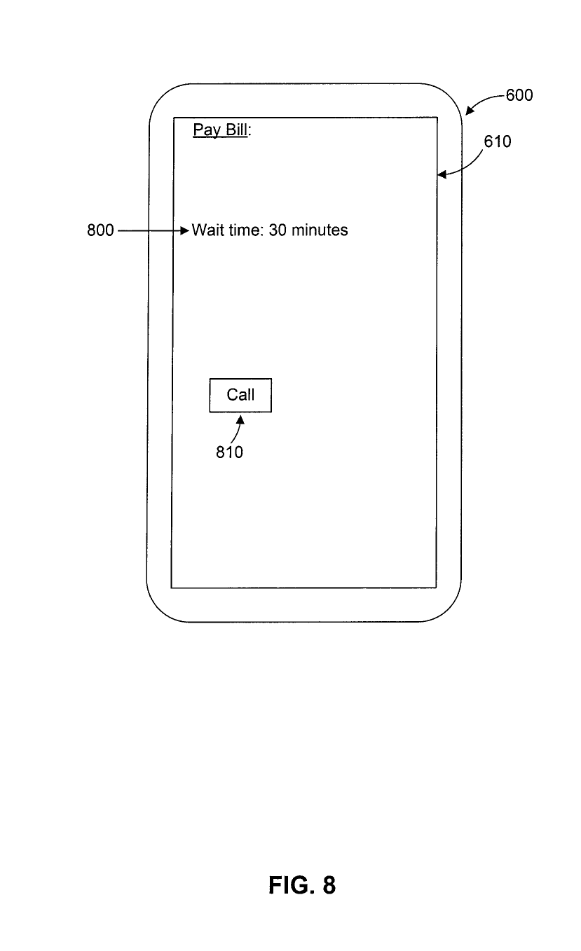

After the user device receives the wait time, the wait time may be displayed (step 350). For example, as depicted in FIG. 8, the wait time 800 may be displayed on the display 610. In some embodiments, the user device periodically updates the displayed wait time 800. For example, in embodiments in which the CSR system places the user device on the waiting list in step 340, the displayed wait time periodically decreases over time. In some embodiments, the wait time is periodically re-determined by, for example, repeating steps 340-350.

In some embodiments, as depicted in FIG. 8, an indication of the determined user reason for the call is also displayed on the user device 600 (e.g. “Pay Bill”). In addition, in some embodiments, as depicted, for example, in FIG. 8, a selectable icon 810 is displayed that enables a call to be initiated to the determined target CSR. For example, the selectable icon 810 may cause the determined target CSR's phone number to be called. Thus, upon selection of the selectable icon 810, the user device may call the target CSR (step 360). In addition, in some embodiments in which the user device has not yet been placed on the waiting list, the user device, after calling the target CSR, is placed on the waiting list.

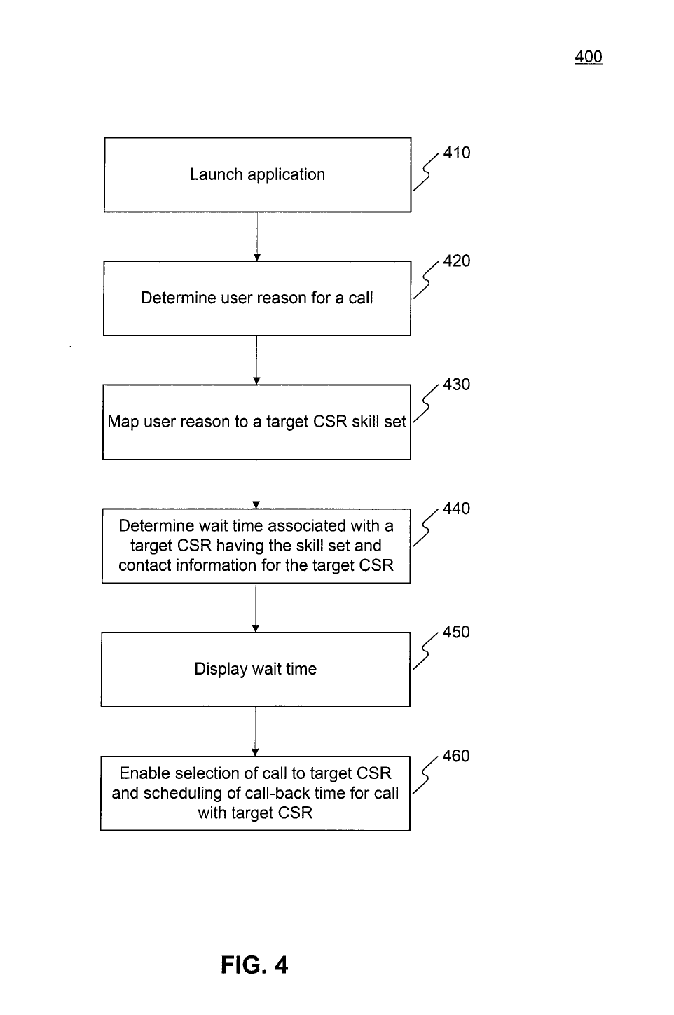

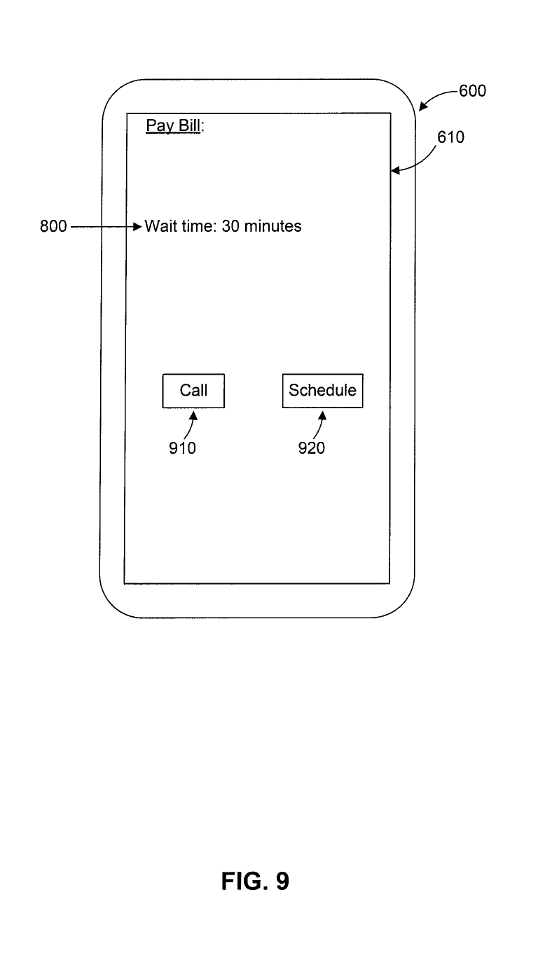

FIG. 4 illustrates an example method 400 for calling a CSR based on a determined user reason for a call. Steps 410-450 of method 400 perform substantially the same operations as steps 310-350 of method 300. In addition, method 400 enables selection of selectable icons 910 and 920, depicted in FIG. 9. Upon selection of icon 910, a call may be initiated to the target CSR, substantially in the same manner as described in regards to selection of icon 810. Upon selection of icon 920, a scheduling operation may be performed to set a call-back time for a call with the target CSR.

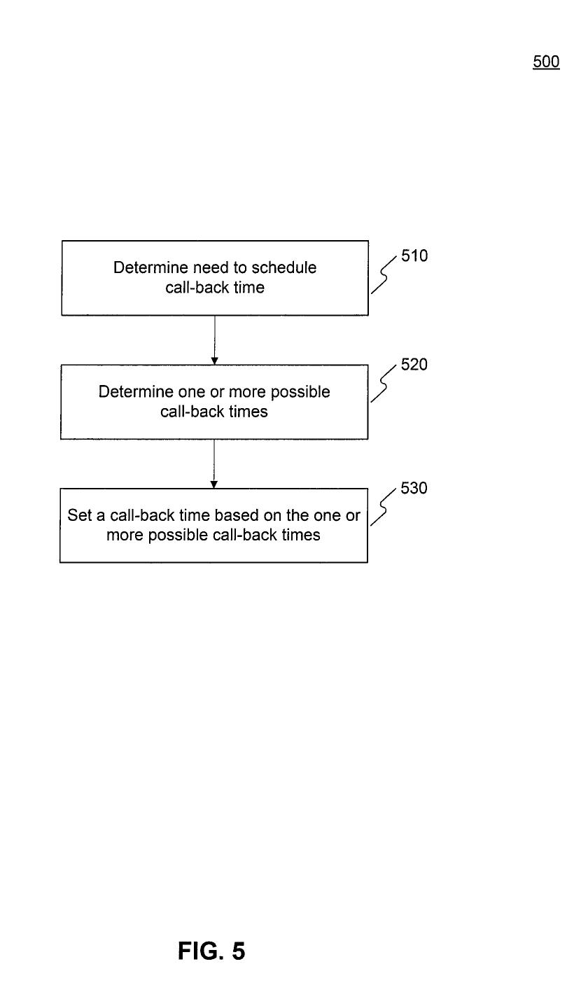

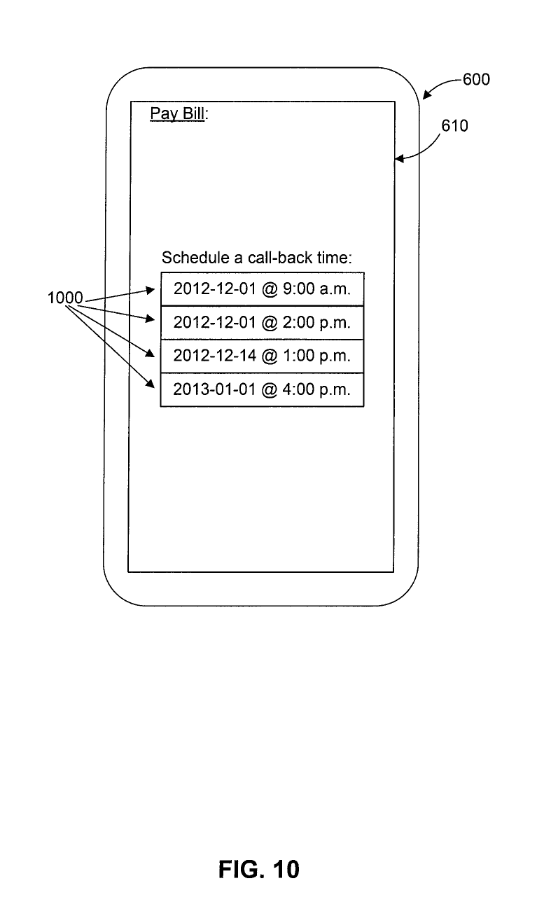

FIG. 5 illustrates an example method 500 for setting a call-back time. Method 500 begins by determining a need to schedule a call-back time (step 510). For example, a selection of scheduling icon 920 may be detected. Method 500 then determines one or more possible call-back times (step 520). One or more possible call-back times may be determined by analyzing a set of factors, such as, for example, the determined wait time, scheduled events in the user device (e.g., scheduled events in a calendar application), unscheduled times in the user device (e.g., times in a calendar application when no scheduled events are present), and/or hours of operation for the target CSR. After determining one or more possible call-back times, a call back time may be set (step 530). In some embodiments, the call-back time is set as the first available call-back time (e.g., a first unscheduled time in a calendar application that occurs after the determined wait time). In other embodiments, the user device displays a plurality of selectable call-back times, and sets the call-back time based on a selection of one of the call-back times. For example, as depicted in FIG. 10, a plurality of selectable icons 1000 may be displayed, each of which indicates one of the possible call-back times. In some embodiments, when the call-back time is reached, the target CSR initiates a call to the user device. In other embodiments, when the call-back time is reached, the user device calls the target CSR. In some embodiments, when a call is made based on a call-back time, the call is not placed on a waiting list and does not wait for a wait time associated with a waiting list.

Embodiments and all of the functional operations described in this specification can be implemented in digital electronic circuitry, or in computer software, firmware, or hardware, including the structures disclosed in this specification and their structural equivalents, or in combinations of them. Embodiments can be implemented as one or more computer program products, i.e., one or more modules of computer program instructions encoded on a computer readable medium, e.g., a machine readable storage device, a machine readable storage medium, a memory device, or a machine readable propagated signal, for execution by, or to control the operation of, data processing apparatus.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal, which is generated to encode information for transmission to suitable receiver apparatus.

A computer program (also referred to as a program, software, an application, a software application, a script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Moreover, a computer can be embedded in another device, e.g., a mobile telephone, a personal digital assistant (PDA), a mobile audio player, a Global Positioning System (GPS) receiver, automotive (e.g., car) dashboards to name just a few. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVDROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client/server relationship to each other.

Certain features which, for clarity, are described in this specification in the context of separate embodiments, may also be provided in combination in a single embodiment. Conversely, various features which, for brevity, are described in the context of a single embodiment, may also be provided in multiple embodiments separately or in any suitable sub-combination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments have been described. Other embodiments are within the scope of the following claims.

What is claimed is:

1. A method for a device having a processor, a display, and an input apparatus, comprising:
receiving one or more input selections from the input apparatus;
determining a set of characteristics representative of one or more customer service representative skills;
outputting the set of characteristics to a server;
receiving data regarding a target customer service representative associated with the set of characteristics; and
enabling the device to communicate with the target customer service representative using the received data.

2. The method of claim 1, wherein enabling the device to communicate with the target customer service representative further comprises:
displaying a scheduled-call icon for selection;
detecting a selection of the scheduled-call icon;
analyzing calendar data stored in the device; and
outputting scheduling data to the server based, at least in part, on the analyzing of the calendar data.

3. The method of claim 2, wherein the received data includes a wait time associated with the target customer service representative, and wherein outputting scheduling data to the server is further based, at least in part, on the wait time.

4. The method of claim 1, wherein the received data includes a wait time associated with the target customer service representative, further comprising:
displaying the wait time.

5. The method of claim 1, wherein determining the set of characteristics further comprises:
mapping the one or more input selections to the set of characteristics using stored relationships between possible input selections and possible sets of characteristics.

6. The method of claim 1, further comprising:
initiating a call from the device to the target customer service representative using the received data.

7. A system, comprising:
one or more processors;
one or more memories;
one or more displays;
program code stored in the one or more memories, which, when executed by the one or more processors, causes the system to perform the steps of:
receiving one or more input selections from the input apparatus;
determining a set of characteristics representative of one or more customer service representative skills;
outputting the set of characteristics to a server;
receiving data regarding a target customer service representative associated with the set of characteristics; and
enabling the device to communicate with the target customer service representative using the received data.

8. The system of claim 6, wherein enabling the device to communicate with the target customer service representative further comprises:
displaying a scheduled-call icon for selection;
detecting a selection of the scheduled-call icon;
analyzing calendar data stored in the device; and
outputting scheduling data to the server based, at least in part, on the analyzing of the calendar data.

9. The method of claim 7, wherein the received data includes a wait time associated with the target customer service representative, and wherein outputting scheduling data to the server is further based, at least in part, on the wait time.

10. The system of claim 6, wherein the received data includes a wait time associated with the target customer service representative, wherein the program code, when executed by the one or more processors, further causes the system to perform the step of:
displaying the wait time.

11. The system of claim 1, wherein determining the set of characteristics further comprises:
mapping the one or more input selections to the set of characteristics using stored relationships between possible input selections and possible sets of characteristics.

12. The system of claim 11, wherein the program code, when executed by the one or more processors, further causes the system to perform the step of:
initiating a call from the device to the target customer service representative using the received data.

13. A method for a server, comprising:
receiving a set of characteristics representative of one or more customer service representative skills from a device;
determining a target customer service representative associated with the received set of characteristics;
determining contact data and time data regarding the target customer service representative; and
outputting the contact data and the time data to the device.

14. The method of claim 11, further comprising:
receiving scheduling data reflecting a time for the target customer service representative to communicate with the device.

15. The method of claim 11, wherein determining the target customer service representative further comprises:
comparing skills of a plurality of possible customer service representatives to the received set of characteristics.

16. The method of claim 11, wherein the time data comprises a wait time associated with the target customer service representative.

17. A server, comprising:
one or more processors;
one or more memories;
program code stored in the one or more memories, which, when executed by the one or more processors, causes the server to perform the steps of:
receiving a set of characteristics representative of one or more customer service representative skills from a device;
determining a target customer service representative associated with the received set of characteristics;
determining contact data and time data regarding the target customer service representative; and
outputting the contact data and the time data to the device.

18. The server of claim 17, wherein the program code, when executed by the one or more processors, further causes the system to perform the step of:
receiving scheduling data reflecting a time for the target customer service representative to communicate with the device.

19. The server of claim 17, wherein determining the target customer service representative further comprises:
comparing skills of a plurality of possible customer service representatives to the received set of characteristics.

20. The server of claim 17, wherein the time data comprises a wait time associated with the target customer service representative.
